(19) United States
(12) Patent Application Publication
(10) Pub. No.: US 2023/0362113 A1
(43) Pub. Date: Nov. 9, 2023

(54) INFORMATION PROVISION AND ACCESS CONTROL

(71) Applicant: Every Two Minutes, Inc., Ann Arbor, MI (US)

(72) Inventor: Erin Rose, Huntington Woods, MI (US)

(21) Appl. No.: 18/246,022

(22) PCT Filed: Sep. 23, 2021
(86) PCT No.: PCT/US2021/051768

§ 371 Date: Mar. 20, 2023

Related U.S. Application Data
(60) Provisional application No. 63/083,582, filed on Sep. 25, 2020.

(51) Int. Cl. H04M 1/72454; H04L 51/04; H04M 1/72457

(52) U.S. Cl. CPC H04L 51/04; H04M 1/72454; H04M 1/72457

(57) ABSTRACT

Information provision and access control in a networked environment may include measures to override conventional communication operation (e.g., chat) to provide anonymity and/or otherwise restrict data exposure. Access control groups may be defined on an ad hoc basis or on the basis of pre-defined potential associations, which associations themselves may be customized for particular contexts.

### CROSS REFERENCE TO RELATED APPLICATIONS

This is related to, and claims the benefit of, provisional patent application 63/083,582, titled “Information Provision and Access Control”, filed in the U.S. Pat. Office on Sep. 25, 2020. That application is hereby incorporated by reference in its entirety.

### BACKGROUND

Networked computer systems provide a uniquely challenging environment for ensuring that access to data is appropriately targeted, and that restricted information is not inadvertently exposed to unauthorized individuals. This can be particularly problematic in end user facing systems, where individuals who interact with network resources may not comply (whether intentionally or not) with defined policies or best practices. However, while end user facing systems may present particular challenges in terms of compliance, the need for effective information targeting and restriction by and for users of such systems can be significant, such as to avoid exposure of personally identifiable information or other sensitive data. Accordingly, there is a need for improved technology for information provision and access control in a network environment.

### SUMMARY

Improved information distribution and control may improve both security and utility of information. Various combinations of anonymous communication, role based information access, automatic information distribution and other functionality may enable users to access appropriate information without compromising privacy or similar restrictions on the information being provided.

An implementation relates to a system comprising: (a) a mobile device operable by a chat requestor to submit an anonymous chat request to an information server, wherein the anonymous chat request comprises a profile identifier for the chat requestor and a profile identifier for an intended chat recipient; (b) the information server, wherein the information server is adapted to, in response to receiving the anonymous chat request, perform a set of steps comprising: (i) retrieving an endpoint for the intended chat recipient from an application database; (ii) creating a synthetic chat request, wherein the synthetic chat request comprises: (A) an endpoint corresponding to the chat requestor; and (B) the endpoint for the intended chat recipient; (iii) sending the synthetic chat request to a chat server; and (iv) storing a record identifying the synthetic chat request as corresponding to the anonymous chat request

In some implementations of a system, such as that described in the second paragraph of this summary, the synthetic chat request does not comprise the profile identifier or any human intelligible identifier for the chat requestor.

In some implementations of a system such as that described in any of the second or third paragraphs of this summary, (a) the endpoint corresponding to the chat requestor is a first internet protocol address; and (b) the endpoint for the intended chat recipient is a second internet protocol address.

In some implementations of a system such as that described in any of the second through fourth paragraphs of this summary, (a) the mobile device is operable to: (i) present the chat requestor an interface listing individuals having one or more designated roles as potential chat recipients; and allow the chat requestor to create the anonymous chat request by selecting an individual from the interface listing individuals having one or more designated roles; and (b) the profile identifier for the intended chat recipient which is comprised by the anonymous chat request identifies the individual selected from the interface listing individuals having one or more designated roles.

In some implementations of a system such as that described in the fifth paragraph of this summary, (a) the mobile device is operable to transmit geolocation for the chat requestor to the information server; (b) the information server is configured to determine the context of the chat requestor by performing steps comprising: (i) receiving location information from the mobile device; (ii) comparing location information received from the mobile device with location information previously received for a plurality of predefined events; and (iii) based identifying a predefined event from the plurality of predefined events having location information matching location information received from the mobile device, identify that predefined event as the context of the chat requestor.

In some implementations of a system such as that described in the fifth paragraph of this summary, (a) the mobile device is operable by the chat requestor to specify that the chat requestor is present at an event; and (b) the information server is configured to determine the context of the chat requestor based on receiving a signal from the mobile device indicating that the chat requestor is present at the event.

Another implementation relates to a system comprising: (a) a mobile device operable by a user to submit a sign up request to an information server; (b) the information server, wherein the information server is configured to perform steps comprising: (i) based on receiving the sign up request from the mobile device, determining if the user is associated with an entity that has been enabled for expanded functionality; (ii) based on a determination that the user is associated with an entity that has not been enabled for expanded functionality, triggering an enablement workflow for the entity associated with the user; and (iii) based on a determination that the entity associated with the user has been enabled for expanded functionality, providing the user access to an expanded set of features for the mobile application during a trial period.

In some implementations of a system such as that described in the eighth paragraph of this summary, determining if the user is associated with an entity that has been enabled for expanded functionality comprises determining if sign up requests had been received from at least a threshold amount of users other than the user.

In some implementations of a system such as that described in the ninth paragraph of this summary, triggering the enablement workflow for the entity associated with the user comprises triggering the mobile device to provide an interface prompting the user to invite other users associated with the entity associated with the user to submit sign up requests.

In some implementations of a system such as that described in the eighth paragraph of this summary, determining if the user is associated with an entity that has been enabled for expanded functionality comprises determining whether a set of required information had been provided for the entity associated with the user.

In some implementations of a system such as that described in the eleventh paragraph of this summary, triggering the enablement workflow for the entity associated with the user comprises sending a message to an administrator device, wherein the message sent to the administrator device requests the administrator to provide the set of required information for the entity associated with the user.

In some implementations of a system such as that described in any of the eighth through twelfth paragraphs of this summary, the steps the information server is configured to perform comprise: (a) when triggering the enablement workflow for the entity associated with the user, storing information indicating that the sign up request had been received from the user; (b) determining whether the enablement workflow for the entity associated with the user has been completed; and (c) based on a determination that the enablement workflow for the entity associated with the user has been completed, sending a message to the user indicating that the entity associated with the user has been enabled for expanded functionality.

In some implementations of a system such as that described in any of the eighth through thirteenth paragraphs of this summary, (a) the system comprises a database storing a plurality of email domain records, wherein each email domain record comprises: (i) an email domain which is not comprised by any other of the plurality of email domain records; (ii) a field adapted to store an entity corresponding to the email domain comprised by that email domain record; (b) the sign up request comprises an email domain for the user; and (c) determining if the user is associated with an entity that has been enabled for expanded functionality comprises querying the database storing the plurality of email domain records with the email domain comprised by the sign up request.

In some implementations of a system such as that described in any of the eighth through fourteenth paragraphs of this summary, (a) the entity associated with the user is a geographic area; and (b) the sign up request comprises a location for the user.

In some implementations of a system such as that described in any of the eighth through fifteenth paragraphs of this summary, (a) the system comprises an organization database comprising, for each entity from a plurality of entities, a set of organizations associated with that entity; (b) the information server is configured to determine a set of potential organizations based on querying the organization database with the entity associated with the user; and (c) the mobile device is adapted to provide a profile interface customized based on the entity associated with the user that is operable to: (i) display a list comprising the set of potential organizations; and (ii) allow the user to specify an affiliation with an organization from the set of potential organizations.

Another implementation relates to a system comprising: (a) an information server; (b) a physiological sensor adapted to collect physiological data from a user; and (c) a mobile device associated with the user and configured with instructions operable to, when executed, to cause it to perform acts comprising: (i) operating in a first mode, wherein, when operating in the first mode, the mobile device performs acts comprising analyzing physiological data from the user and determining, based on the analysis of the physiological data from the user, whether to operate in a second mode; (ii) operating in the second mode, wherein, when operating in the second mode, the mobile device performs acts comprising: (A) capturing location information through a location sensor of the mobile device; (B) capturing audio information through a microphone of the mobile device; and (C) transferring the audio information, the location information, and the physiological data to the information server.

In some implementations of a system such as that described in the seventeenth paragraph of this summary, (a) the physiological sensor is a heart rate sensor; (b) the mobile device is configured to establish a baseline heart rate variability for the user; (c) analyzing the physiological data from the user comprises determining: (i) the user’s heart rate variability; and (ii) whether the user has had a decrease in heart rate variability relative to the baseline heart rate variability for the user.

In some implementations of a system such as that described in any of the seventeenth through eighteenth paragraphs of this summary, the information server is adapted to: (a) store data identifying a plurality of other users as being comprised by an active group for the user; and (b) based on the mobile device operating in the second mode, sending a notification to each of the other users identified as being comprised by the active group for the user.

In some implementations of a system such as that described in any of the seventeenth through nineteenth paragraphs of this summary, the information server is adapted to: (a) identify an emergency services number based on the location information transferred from the mobile device; and (b) based on the mobile device operating in the second mode, providing an interface operable by the user to access emergency services using the identified emergency services number.

In some implementations of a system such as that described in any of the seventeenth through twentieth paragraphs of this summary, (a) the system comprises a plurality of additional mobile devices, each of which is adapted to display a map interface; and (b) the information server is adapted to, based on the mobile device operating in the second mode, communicating information to each of the plurality of additional mobile devices causing that mobile device to display a hazard marker on the map interface at a location corresponding to the location information captured through the location sensor of the mobile device associated with the user.

Another implementation relates to a method performed by an information server, the method comprising: (a) receiving an anonymous chat request from a mobile device, wherein the anonymous chat request comprises a profile identifier for a chat requestor and a profile identifier for an intended chat recipient; (b) in response to receiving the anonymous chat request: (i) retrieving an endpoint for the intended chat recipient from an application database; (ii) creating a synthetic chat request, wherein the synthetic chat request comprises: (A) an endpoint corresponding to the chat requestor; and (B) the endpoint for the intended chat recipient; (iii) sending the synthetic chat request to a chat server; and (iv) storing a record identifying the synthetic chat request as corresponding to the anonymous chat request.

In some implementations of a method such as described in the twenty second paragraph of this summary, the synthetic chat request does not comprise the profile identifier or any human intelligible identifier for the chat requestor.

In some implementations of a method such as described in any of the twenty second through twenty third paragraphs of this summary, (a) the endpoint corresponding to the chat requestor is a first internet protocol address; and (b) the endpoint for the intended chat recipient is a second internet protocol address.

In some implementations of a method such as described in any of the twenty second through twenty fourth paragraphs of this summary, (a) the mobile device is operable to: (i) present the chat requestor an interface listing individuals having one or more designated roles as potential chat recipients; and (ii) allow the chat requestor to create the anonymous chat request by selecting an individual from the interface listing individuals having one or more designated roles; and (b) the profile identifier for the intended chat recipient which is comprised by the anonymous chat request identifies the individual selected from the interface listing individuals having one or more designated roles.

In some implementations of a method such as described in the twenty fifth paragraph of this summary, (a) the mobile device is operable to transmit geolocation for the chat requestor to the information server; (b) the information server is configured to determine the context of the chat requestor by performing steps comprising: (i) receiving location information from the mobile device; (ii) comparing location information received from the mobile device with location information previously received for a plurality of predefined events; and (iii) based identifying a predefined event from the plurality of predefined events having location information matching location information received from the mobile device, identify that predefined event as the context of the chat requestor.

In some implementations of a method such as described in the twenty fifth paragraph of this summary, (a) the mobile device is operable by the chat requestor to specify that the chat requestor is present at an event; and (b) the information server is configured to determine the context of the chat requestor based on receiving a signal from the mobile device indicating that the chat requestor is present at the event.

Another implementation relates to a method performed by an information server, the method comprising: (a) receiving a sign up request from a mobile device; (b) based on receiving the sign up request from the mobile device, determining if a user of the mobile device is associated with an entity that has been enabled for expanded functionality; (c) based on a determination that the user is associated with an entity that has not been enabled for enhanced functionality, triggering an enablement workflow for the entity associated with the user; (d) based on completion of the enablement workflow, making a determination that the entity associated with the user has been enabled for expanded functionality; and (e) based on the determination that the entity associated with the user has been enabled for expanded functionality, providing the user access to an expanded set of features for the mobile application during a trial period.

In some implementations of a method such as described in the twenty eighth paragraph of this summary, determining if the user is associated with an entity that has been enabled for expanded functionality comprises determining if sign up requests had been received from at least a threshold amount of users other than the user.

In some implementations of a method such as described in the twenty ninth paragraph of this summary, triggering the enablement workflow for the entity associated with the user comprises triggering the mobile device to provide an interface prompting the user to invite other users associated with the entity associated with the user to submit sign up requests.

In some implementations of a method such as described in the twenty eighth paragraph of this summary, determining if the user is associated with an entity that has been enabled for expanded functionality comprises determining whether a set of required information had been provided for the entity associated with the user.

In some implementations of a method such as described in the thirty first paragraph of this summary, triggering the enablement workflow for the entity associated with the user comprises sending a message to an administrator device, wherein the message sent to the administrator device requests the administrator to provide the set of required information for the entity associated with the user.

In some implementations of a method such as described in any of the twenty eighth through thirty second paragraphs of this summary, the information server is configured to perform steps comprising: (a) when triggering the enablement workflow for the entity associated with the user, storing information indicating that the sign up request had been received from the user; and (b) based on the determination that the enablement workflow for the entity associated with the user has been completed, sending a message to the user indicating that the entity associated with the user has been enabled for expanded functionality.

In some implementations of a method such as described in any of the twenty eighth through thirty third paragraphs of this summary, (a) the sign up request comprises an email domain for the user; and (b) determining if the user is associated with an entity that has been enabled for expanded functionality comprises querying a database storing a plurality of email domain records.

In some implementations of a method such as described in any of the twenty eighth through thirty fourth paragraphs of this summary, (a) the entity associated with the user is a geographic area; and (b) the sign up request comprises a location for the user.

In some implementations of a method such as described in any of the twenty eighth through thirty fifth paragraphs of this summary, (a) the information server is configured to determine a set of potential organizations based on querying an organization database with the entity associated with the user; and (b) the mobile device is adapted to provide a profile interface customized based on the entity associated with the user is operable to: (i) display a list comprising the set of potential organizations; and (ii) allow the user to specify an affiliation with an organization from the set of potential organizations.

Another implementation relates to a method performed by a mobile device, the method comprising: (a) operating in a first mode, wherein when operating in the first mode, the mobile device performs acts comprising: (i) analyzing physiological data for a user; and (ii) determining, based on the analysis of the physiological data from the user, whether to operate in a second mode; (b) operating in a second mode, wherein when operating in the second mode, the mobile device performs acts comprising: (i) capturing location information through a location sensor; (ii) capturing audio information through a microphone; and (iii) transferring the audio information, the location information, and the physiological data to an information server.

In some implementations of a method such as described in the thirty seventh paragraph of this summary, (a) the mobile device is adapted to gather the physiological data using a heart rate sensor; (b) the mobile device is configured to establish a baseline heart rate variability for the user; (c) analyzing the physiological data from the user comprises determining: (i) the user’s heart rate variability; and (ii) whether the user has had a decrease in heart rate variability relative to the baseline heart rate variability for the user.

In some implementations of a method such as described in any of the thirty seventh through thirty eighth paragraphs of this summary, the information server is adapted to: (a) store data identifying a plurality of other users as being comprised by an active group for the user; and (b) based on the mobile device operating in the second mode, sending a notification to each of the other users identified as being comprised by the active group for the user.

In some implementations of a method such as described in any of the thirty seventh through thirty ninth paragraphs of this summary, the information server is adapted to: (a) identify an emergency services number based on the location information transferred from the mobile device; and (b) based on the mobile device operating in the second mode, providing an interface operable by the user to access emergency services using the identified emergency services number.

In some implementations of a method such as described in any of the thirty seventh through fortieth paragraphs of this summary, the information server is adapted to, based on the mobile device operating in the second mode, communicating information to each of a plurality of additional mobile devices causing each of those mobile devices to display a hazard marker on a map interface at a location corresponding to the location information captured through a location sensor of the mobile device.

Another implementation relates to a system comprising: (a) an information server, configured to maintain data for a plurality of events, wherein, for each event, the data for that event comprises: (i) a location for that event; (ii) a time period for that event; (iii) for each of a plurality of predefined roles, one or more corresponding individuals; and (iv) during the time period for that event, for each individual corresponding to a role from the plurality of predefined roles, whether that individual is present at that event; (b) a plurality of mobile devices, wherein each of the plurality of mobile devices: (i) is communicatively connected to the information server; and (ii) is operable to display a map interface, the map interface corresponding to a geographic area and comprising icons representing one or more events having locations within the geographic area; wherein for each icon comprised by the map interface which represents an event, the map interface provides a signal during the time period of that event based on the presence of one or more individuals corresponding to the one or more predefined roles.

In some implementations of a system such as described in the forty second paragraph of this summary, for each icon comprised by the map interface for which the signal is provided, the signal is a marker displayed with that icon.

In some implementations of a system such as described in any of the forty second or forty third paragraphs of this summary, for each mobile device from the plurality of mobile devices, the one or more events having locations within the geographic area represented by icons on the map interface are determined based on the information server maintaining data indicating that those events are public events or are private events to which a user associated with that mobile device has been invited.

In some implementations of a system such as described in any of the forty second through forty fourth paragraphs of this summary, (a) the one or more predefined roles comprises a plurality of predefined roles; and (b) for each mobile device from the plurality of mobile devices, for each of the one or more events represented by icons on the map interface, that mobile device is operable to provide the signal during the time period of that event based on at least one individual corresponding to at least one of the predefined roles for that event being present at that event.

Another implementation relates to a method comprising: (a) an information server maintaining data for a plurality of events, wherein, for each event, the data for that event comprises: (i) a location for that event; (ii) a time period for that event; (iii) for each of a plurality of predefined roles, one or more corresponding individuals; and (iv) during the time period for that event, for each individual corresponding to a role from the plurality of predefined roles, whether that individual is present at that event; (b) the information server sending, to each mobile device of a plurality of mobile devices, data operable to configure that mobile device to display a map interface, the map interface corresponding to a geographic area and comprising icons representing one or more events having locations within the geographic area; wherein for each icon comprised by the map interface which represents an event, the map interface provides a signal during the time period of that event based on the presence of one or more individuals corresponding to the one or more predefined roles.

In some implementations of a method such as described in the forty sixth paragraph of this summary, for each icon comprised by the map interface for which the signal is provided, the signal is a marker displayed with that icon.

In some implementations of a method such as described in any of the forty sixth or forty seventh paragraphs of this summary, for each mobile device from the plurality of mobile devices, the one or more events having locations within the geographic area represented by icons on the map interface are determined based on the information server maintaining data indicating that those events are public events or are private events to which a user associated with that mobile device has been invited. In some implementations of a method such as described in any of the forty sixth through forty eighth paragraphs of this summary, (a) the one or more predefined roles comprises a plurality of predefined roles; and (b) for each mobile device from the plurality of mobile devices, for each of the one or more events represented by icons on the map interface, that mobile device is operable to provide the signal during the time period of that event based on at least one individual corresponding to at least one of the predefined roles for that event being present at that event.

It should be appreciated that all combinations of the foregoing concepts and additional concepts discussed in greater detail below (provided such concepts are not mutually inconsistent) are contemplated as being part of the inventive subject matter disclosed herein and to achieve the benefits as described herein.

### BRIEF DESCRIPTION OF THE DRAWINGS

The details of one or more implementations are set forth in the accompanying drawings and the description below. Other features, aspects, and advantages will become apparent from the description, the drawings, and the claims, in which:

FIG. 1 depicts a process which may be used in providing real time communication.

FIG. 2 depicts a system which may be used in providing real time communication.

FIG. 3 depicts a menu interface which could be displayed in a mobile application.

FIG. 4 depicts an event interface which could be displayed in a mobile application.

FIG. 5 depicts a process which could be implemented for event information management

FIG. 6 depicts an interface which could be presented in a mobile application.

FIG. 7 depicts an interface which could be presented for selection of real time communication modes.

FIG. 8 depicts an interface which could be displayed to support role authorization delegation.

FIG. 9 depicts a process which could be used for triggering associations.

FIG. 10 depicts a process for reporting hazards.

FIG. 11 depicts an interface for specifying a hazard setting.

FIG. 12 depicts an interface for providing expanded hazard information.

FIG. 13 depicts a map presentation interface.

FIG. 14 depicts a map presentation interface.

FIG. 15 depicts a method which may be performed in which an individual would be associated with an institution that has already been enabled.

FIG. 16 depicts a process that some embodiments may use when a user tries to sign up with an email address for an institution that had not been enabled.

It will be recognized that some or all of the figures are schematic representations for purposes of illustration. The figures are provided for the purpose of illustrating one or more implementations with the explicit understanding that they will not be used to limit the scope or the meaning of any claims included in this document or any related document.

### DETAILED DESCRIPTION

Disclosed herein is novel technology which can be used for a variety of purposes, including improved access control and information provision in a network environment. It should be understood that, while the present disclosure focuses on embodiments in which the disclosed technology is used for improving the operation of systems used to distribute and control access to time sensitive and/or personal information, and in particular to distribute and control access to such information in the context of safety information and anonymous communications in an educational setting, the disclosed technology can be used in other contexts as well, such as for unique role based access permission and definition in non-educational settings. Accordingly, the exemplary embodiments described herein should be understood as being illustrative only, and should not be treated as limiting on the protection provided by this document or any related document.

As an example of a practical application for aspects of the disclosed technology, consider real time chat. Conventionally, when an end user of a mobile device activates real time chat capability, his or her identity will be provided to a chat server which will establish a connection with the intended chat recipient(s) and then communicate data between them for the duration of the chat session. In the process of this communication, each participant in the chat session will be provided with sufficient information to communicate with the other participants, as well as potentially other information, such as personal identifiers or links to profiles or similar information. This additional information sharing can be a significant drawback, as there may be contexts in which a user may want to engage in real time chat without exposing additional information, and potentially without enabling other participants in the chat session to restart communications once the initial chat session has concluded.

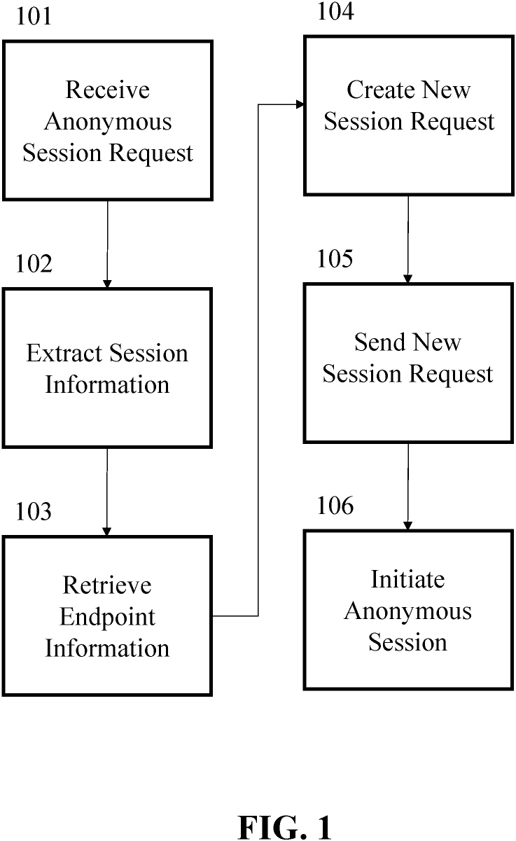

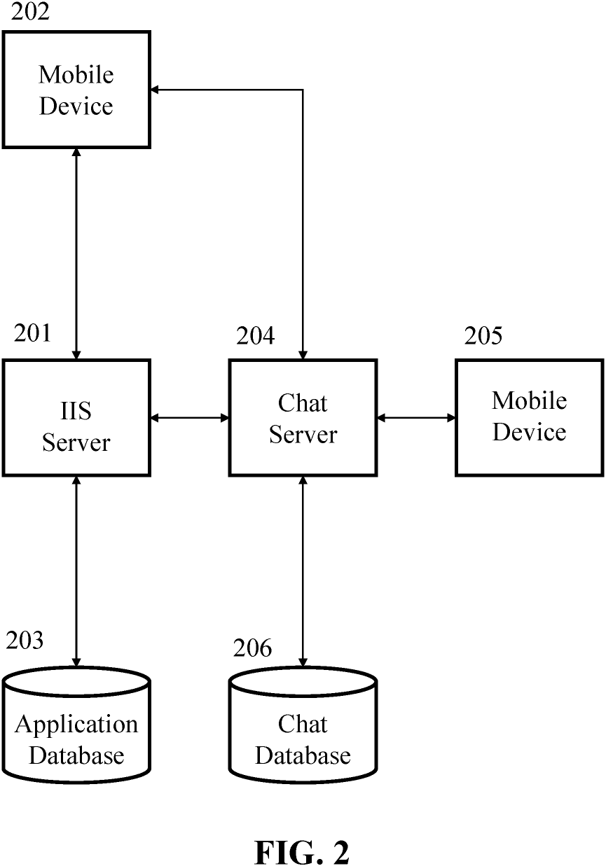

FIG. 1 and FIG. 2 illustrate a process and system in which the conventional sequence of events associated with activation of real time chat capability is overridden to provide for real time chat without the information leakage described above. Initially, in an embodiment in which the process of FIG. 1 is performed using a system such as shown in FIG. 2, an internet information services (IIS) server 201 receives 101 a request from a mobile device 202 for an anonymous chat session. After receiving 101 the request, the IIS server 201 will extract 102 chat information, such as a profile identifier for an individual who was logged in to the device 202 that requested the chat session, and one or more profile identifiers for the individual(s) the chat requestor wished to communicate with. The IIS server 201 could then use this information to retrieve 103 endpoint information (e.g., IP addresses) for the mobile devices and chat applications of the chat requestor and the people he or she wished to communicate with in an application database 203.

In an embodiment following the method of FIG. 1, after the IIS server 201 retrieved 103 the endpoint information, it could use this information to create 104 a new chat session request which would appear to come from an anonymous user having the same endpoint information as the user who originally requested the anonymous chat. This request would then be sent 105 to a chat server 204, which would use it to initiate 106 an anonymous session between the device of the original requestor 202 and the device of the user the requestor desired to chat with 205. Thereafter, this chat could proceed conventionally as if the original chat request had been sent directly to the chat server 204, and the IIS server 201 could maintain records of the relationship between the original chat request and the new chat request sent to the chat server 204, so that if there was a subsequent need to retrieve a log of the chat from the chat server’s database 206, this could be done by matching the records from the IIS server 201 without the chat requestor to ever reveal his or her identity.

To further illustrate how anonymous chat may be provided in some embodiments, consider a concrete case in which the chat server 204 is a server running the ejabberd chat software available from ProcessOne at https://www/ejabberd.im. In such a case, when an anonymous chat request was made, such as by an attendee at an event requesting anonymous chat with a user having the predefined role of sober monitor (discussed in more detail infra), the IIS server 201 could use XMPP MUC services exposed by the chat server 204 to create an anonymous group chat with a name that identifies the target of the anonymous chat request (e.g., the sober monitor’s role and/or name). This anonymous group chat could then proceed with the participants being the individual who originally requested the anonymous chat and the target of the initial request, so the original requestor will know that the chat was correctly directed (i.e., that the person he or she is chatting with is the sober monitor) while the target of the anonymous chat request will not be provided with the original requestor’s identity.

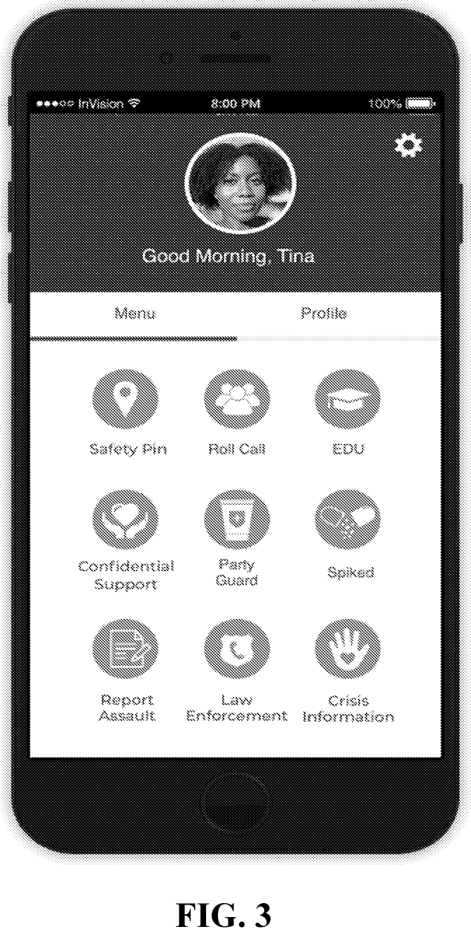

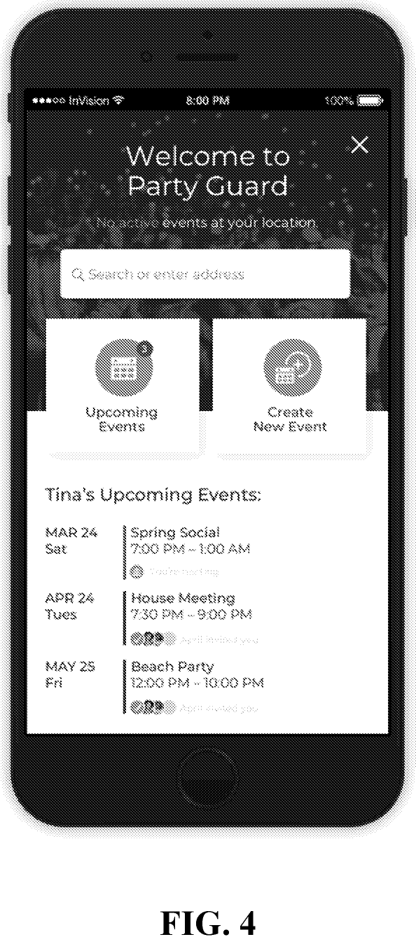

In some embodiments providing anonymous chat as described in the context of FIGS. 1 and 2, this anonymity may be supported by functionality which would automatically identify people with whom a user may want to establish anonymous chat session, thereby facilitating the submission of requests such as described previously in the context of FIGS. 1 and 2. For example, in an embodiment designed to be used in an educational context to protect student safety and security, there might be functionality provided to allow parties to be defined such that individuals with roles such as sober monitor or risk manager could be identified and automatically made available to party attendees for anonymous chat or other types of interactions. To illustrate, FIGS. 3-4 depict interfaces which could be displayed when creating a party in such an embodiment.

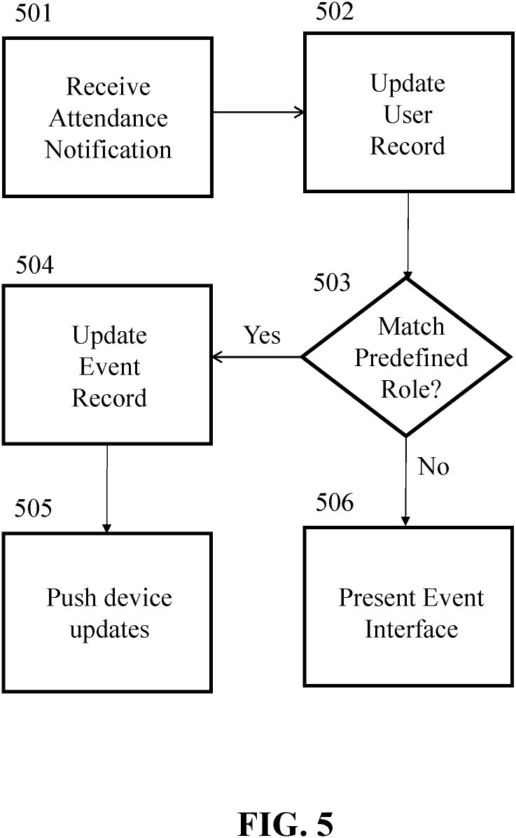

Turning now to FIGS. 3-4, FIG. 3 illustrates a menu interface which could be displayed in a mobile application implemented based on this disclosure. Using such an application, a user could select an event creation function, such as by selecting the event functionality shown from a menu such as that of FIG. 3 (e.g., “Party Guard”), then selecting to create a new event using an interface such as shown in FIG. 4. After the user had indicated that he or she wanted to create a new event, then, in addition to allowing him or her to specify event details (e.g., time, date, location, whether the event is public or private and whether guests can invite friends), some embodiments may also allow the user to specify (or invite) individuals to fill particular roles, such as the party monitor or risk manager roles noted previously. Subsequently, when the event was in progress, an event check in feature could be used to both identify that individuals having the risk manager and/or sober monitor (or other) roles were present, and to determine how to populate interfaces of applications used by other event attendees to make such individuals easily (and potentially anonymously) available. A flowchart showing how this might take place is provided in FIG. 5.

Initially, in the process of FIG. 5, an application server such as the IIS server 201 of FIG. 2 would receive 501 a notification that a mobile device user was attending an event. This could be done, for example, by the mobile device user selecting a then current event from a list of events he or she had been invited to (or from events that he or she could attend, in the case of public events) and activating a “check in” or similar option. Alternatively, in some embodiments a mobile device application could match a user’s location against the locations of then current events he or she could attend, and automatically send a notification to the server if the user’s location overlapped the location of an event he or she could attend at a time when the event was active. As yet another alternative, in some cases a mobile application would identify that a user was in the vicinity of an active event he or she could attend, automatically provide a message asking the user if he or she was attending the event, and then send a notification to the server if the user indicated that he or she was attending the event. Other approaches are also possible, could be implemented without undue experimentation by those of ordinary skill in the art based on this disclosure, and so the discussion of how a server could receive 501 a notification that a mobile device user was attending an event should be understood as being illustrative only, and should not be treated as limiting.

In an embodiment following the process of FIG. 5, after the attendance notification had been received 501, the server could update 502 a user record in its database (e.g., application database 203) to indicate that the user who had checked in was currently attending the event, and may also update other information in the user’s record, such as the current endpoint information for the user’s mobile device to facilitate communications such as those described previously in the context of FIGS. 1-2. The server could also check 503 to see if the user who had just checked in was associated with any pre-defined role (e.g., sober monitor) for the event he or she had just checked in for. If the user was so associated, then a record for the event in the database could be updated 504 to indicate that the user was present, and an update could be pushed 505 to the mobile devices of the other attendees so that they could be made aware that the user with the predefined role was present and be able to initiate communication with him or her (e.g., an anonymous communication as described previously in the context of FIGS. 1-2). Otherwise, if the user was not associated with any pre-defined role for the event he or she had checked in to, then the user could simply be presented 506 with an interface showing the users who were associated with pre-defined roles for the event.

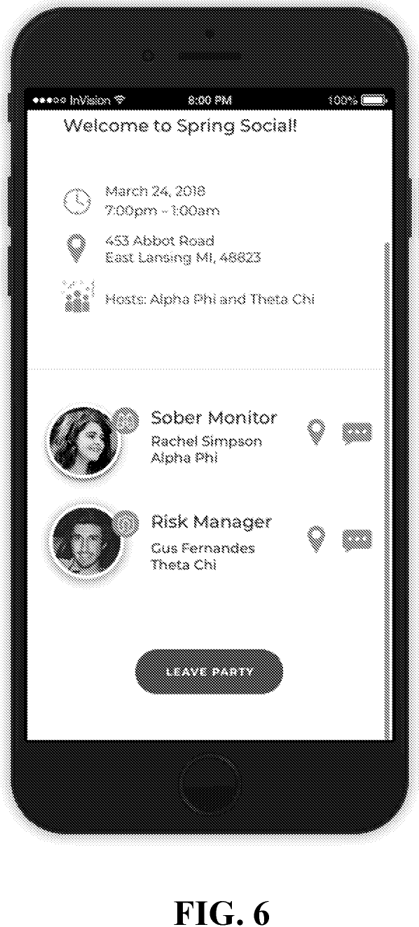

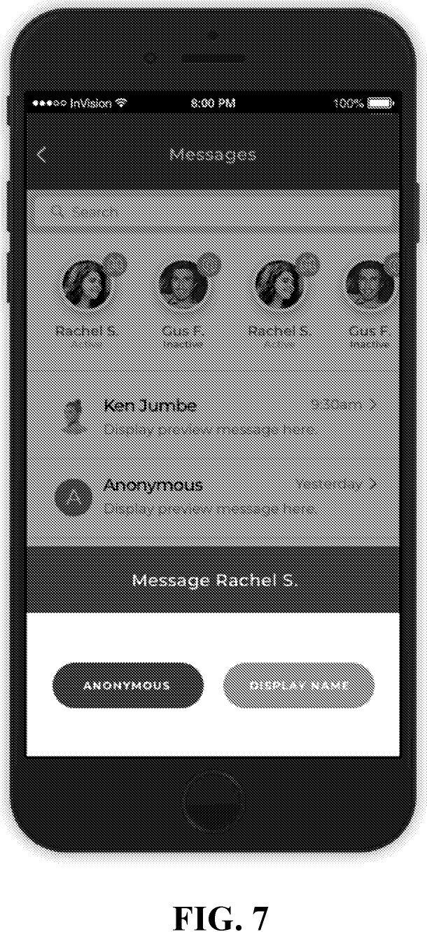

FIG. 6 illustrates an interface which could potentially be presented 506 to a user when he or she checks in to an event notifying him or her of the individuals associated with the pre-defined roles of sober monitor and risk manager. As shown in FIG. 6, some interfaces indicating individuals associated with pre-defined roles may also allow a user to directly contact those individuals, such as by using a chat icon. In some embodiments, activating a chat icon could result in an interface such as shown in FIG. 7 being displayed, allowing the user to either initiate an anonymous chat as described in the context of FIGS. 1-2, or to initiate a chat in which his or her identification would be displayed to the chat recipient.

Of course, it should be understood that, while the above discussion indicated how predefined roles could be used to facilitate anonymous communications, that discussion was intended to be illustrative only, and different (or additional) approaches could also be implemented in some embodiments. For example, in some embodiments, either in addition to, or as an alternative to, an event creator designating who would fill pre-defined roles such as sober monitor and/or risk manager, an event creator could indicate individuals who could fill such pre-defined roles, those individuals would be invited to attend the event in those roles, and those individuals could then respond to those invitations indicating whether they would fill the specified role, or whether they simply preferred to attend the event as a guest. Similarly, in some embodiments, when an individual is invited to attend an event, that individual could indicate that he or she wanted to be a sober monitor or risk manager, and would then be assigned to that role if the person who created the event approved that individual as assuming that role for the event.

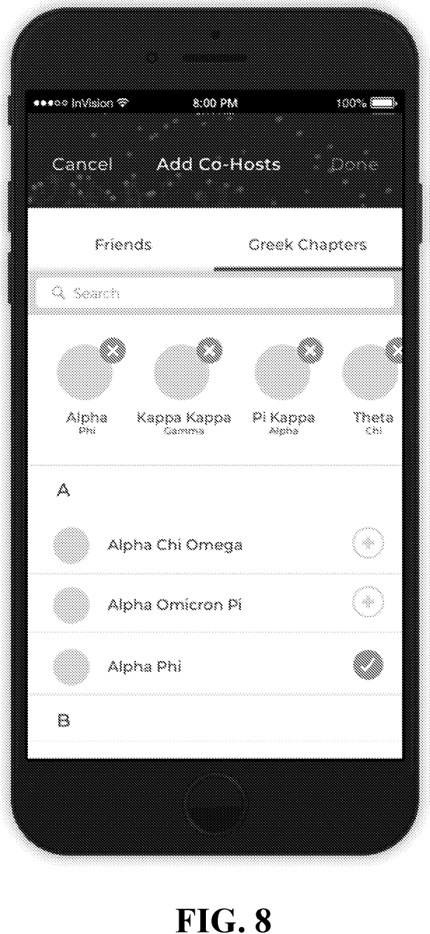

As another example of a type of variation which could be implemented based on this disclosure, in some embodiments, responsibilities/authorizations described above in the context of a creator of event could be shared with other individuals as well. For example, in the case where the disclosed technology is used to create an application which would be used in a collegiate environment, the application may be programmed to include fraternities and/or sororities as default groups, and allow the user who originally created the event (the “host”) who was associated with such an organization to automatically invite everyone in his or her fraternity or sorority chapter to be co-host for an event. An interface which could potentially be presented to support this type of functionality is illustrated in FIG. 8.

While predefined roles such as sober monitor, risk manager and co-host, and predefined groups such as fraternity/sorority chapters may be beneficial, some embodiments may also provide support for user defined groups or roles. For example, in the context of creating an event, rather than only allowing users to invite their fraternity or sorority chapters to co-host an event, some embodiments may allow the individual who created the event (referred to as a “host”) to select other individuals who had previously been identified as friends of the host, or who were present in a user defined group with the host, who should be able to manage the event (e.g., designate and/or approve risk managers and sober monitors) as if they had created it themselves. Additionally, as described below, in some embodiments, the functionality for supporting user created groups may be used in ways other than identifying co-hosts for an event.

In some embodiments, users may be allowed to create groups of friends who will be notified either at the user’s request or when various events take place. For instance, in some embodiments, once users have been connected by identifying each other as friends, they may be able to create a group by selecting the friends they would like to have included in the group. In some embodiments, any member of a group may be able to invite any of his or her friends to join. However, in other embodiments, a user may only be invited to join a group if he or she is already friends with each user who is already in the group and/or the ability to invite new members may be limited (e.g., to the original group creator or others he or she authorizes to send invitations). Subsequently, once a group has been defined, when particular events take place (e.g., a member of a group arrives at or leaves a party or other location, or specifies that other group members should be notified of his or her then current location), the members of the group could be provided a notification in real time, preferably including the location where the event took place. In some embodiments, this notification may be provided to every member of every group that the user who is the subject of the event is part of. However, in other embodiments, a user may be provided the ability to “turn off” particular groups, which could result in notifications associated with that group not being provided to the user (or notifications regarding that user not being provided to the group) until the user decided to turn the group “on” again. In some embodiments, a requirement may be imposed that a user could only have a set number of groups (e.g., five) active at any one time, with the other groups being turned off, so as to ensure that group based notifications would not proliferate and become digital chatter that users would be likely to ignore.

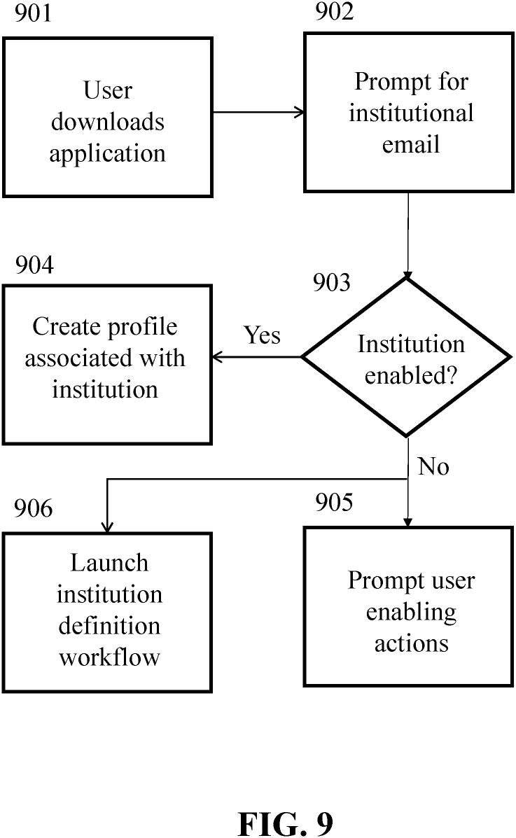

As a supplement to (or, in some embodiments, alternative to) the role and/or group based communication strategies described above, some embodiments may provide functionality for defining institution based information. In embodiments where this type of functionality is present, it could be used to support role based communication as described above, but may also (or alternatively) be used for other types of information targeting. Examples of this type of targeting, as well as of a process for associating users with institutions that could support it, are provided below in the context of FIG. 9.

In embodiments following a process such as shown in FIG. 9, a potential user of an application implemented based on this disclosure would initially download 901 a copy of the application onto his or her mobile device. After the application had been downloaded 901, the user could be prompted 902 to create a profile by entering their school email address. This could then be sent to a backend server (e.g., the IIS server 201 from FIG. 2) which could check 903 in its database (e.g., application database 203) to determine if the potential user’s email was associated with a university that had been enabled for application use. This could be done in a variety of manners. For example, in some embodiments, the check 903 could be whether a threshold number of students (e.g., five students) from that university had already created (or requested to create, by providing their school email addresses) profiles in the system. Alternatively, in other embodiments, the check 903 could be whether a profile with information such as local fraternity/sorority chapters, contact information for local emergency services, and/or other relevant information had already been created. Further alternatives, such as combined approaches in which an institution would be treated as enabled if at least a threshold number of students had requested to create profiles *and* information on local emergency services, etc. had been added. Accordingly, the description above of the determination of whether an institution had been enabled should be treated as being illustrative only, and should not be treated as limiting.

However the determination 903 of whether an institution was enabled takes place, if the institution had been enabled, then the user could proceed to creating 904 a profile which would be automatically associated with his or her institution. This could include tasks such as providing a profile picture, name, and similar information. Additionally, in some embodiments, the association of the profile with the user’s institution could provide additional customization and/or options for the profile. For example, in some embodiments where a university would be associated with an institutional profile specifying Greek chapters on campus, when a user creates 904 a profile, he or she could be presented with an option to select a fraternity/sorority from a list that would be automatically populated based on the information for the university.

Alternatively, if the institution associated with the email provided by a user has not been enabled, a system implemented to utilize a process such as shown in FIG. 9 could trigger one or more workflows to enable the institution and/or prepare information that could be associated with the institution for users. For example, in an embodiment where an institution would only be enabled when a threshold number of users associated with that institution had tried to sign up, then the user could be prompted 905 to invite his or her friends so that the institution would be enabled for all of them. Simultaneously, a backend workflow could be launched 906 indicating that information such as emergency services contact numbers, local laws on reporting intoxication, resources for assistance, fraternity/sorority chapters, etc. should be added to a profile for the institution. In this way, even if no profile was already present for the institution when the first user provided his or her email address, a profile would preferably be both present and populated by the time the institution was enabled.

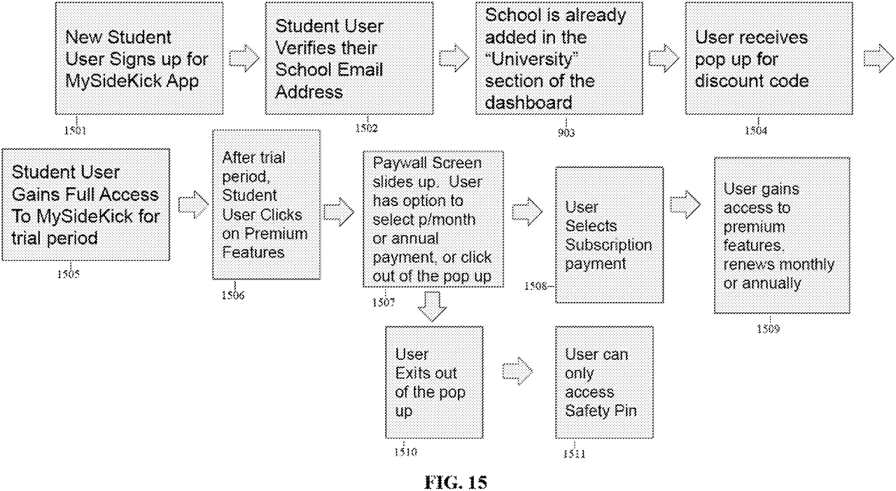

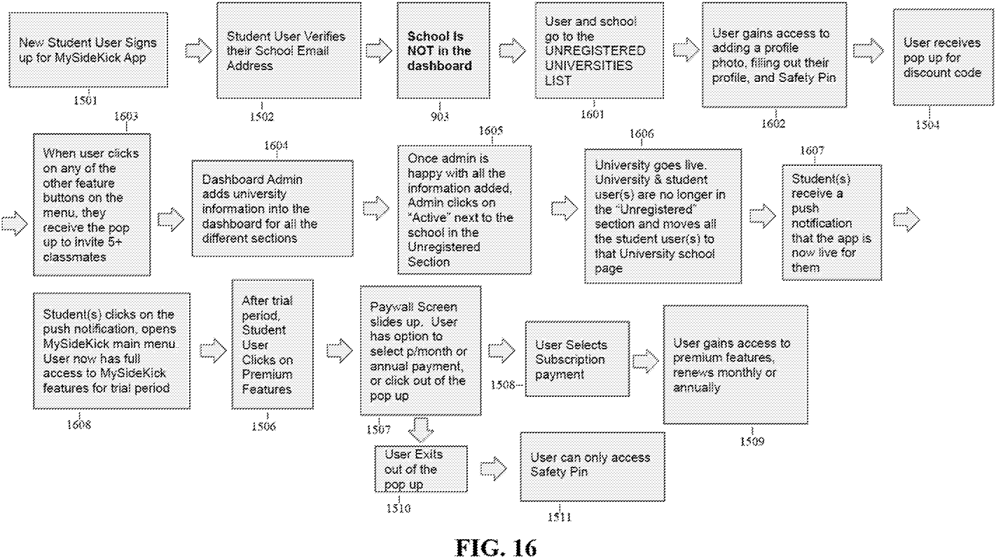

Of course, it should be understood that the description above of populating a profile for an institution, like the description of other steps from FIG. 9 such as determining if an institution is enabled, is intended to be illustrative only, and should not be treated as limiting. For example, in some cases, the process of allowing a user to create a profile and associate himself or herself with an institution may include additional steps, such as those shown in FIGS. 15 and 16. Starting with FIG. 15, that figure illustrates a method which may be performed in which an individual would be associated with an institution that has already been enabled. As show, this method may begin with the user signing up for 1501 (e.g., downloading and providing registration information for) an application implemented based on this disclosure. The user could then be required to verify 1502 his or her email address (e.g., an information server could send an email to an address provided during sign up, and require the user to respond to that email, thereby verifying the account). At this point, a check 903 could be made if the university had already been enabled (e.g., if it was already populated in a “University” section of an administrative dashboard). It is was, the user could be provided 1504 a discount code, and may be provided 1505 with access to the functionality of the application during a trial period. At the conclusion of this trial period, the user may be allowed to select 1506 premium features, and, when he or she does so, a paywall could be provided 1507 which would allow the user to decide if he or she wanted to pay for the features. If the user did want to pay for the features, he or she could be allowed to select 1508 a payment option, and would be provided 1509 access to the full features of the application. Otherwise, he or she could exit 1510 the payment interface, and may be provided 1511 with a reduced set of functionality (e.g., functionality of illustrating hazards on a map interface, as described infra).

FIG. 16 illustrates a process that some embodiments may use as an alternative to FIG. 15 when a user tries to sign up with an email address for an institution that had not been enabled. Initially, the process of FIG. 16 would begin the same manner as the process of FIG. 15, with the user signing up 1501 and verifying 1502 their school email address. However, after the user verifies 1502 his or her email, in the process of FIG. 16 the determination 903 of whether his or her institution has been enabled indicates that it has not. This may be because, for example, a system used in perform the process of FIG. 16 maintains a database of all institutions that have been enabled, along with their corresponding email domains, and the email domain for the student may not be included in the database. In this event, a record may be created 1601 for the user and his or her email domain in a list of institutions that have not yet been enabled. The user may also be given the ability to complete a profile for the application 1602 and a discount code 1504, potentially along with some limited application functionality. In this type of embodiment, if the user tries to access additional features, he or she may be prompted 1603 to take action (e.g., inviting friends from his or her school) to enable his or her associated institution. Additionally, an enablement workflow may be triggered 1604, in which an administrator may add information (e.g., fraternities and sororities) for the university so that this information could be used to customize the user’s interface when the enablement process was complete. When this workflow is complete, the administrator may indicate 1605 that the university is enabled, such as by actuating an activate control in an interface listing institutions that were awaiting enablement. This may cause the university to be enabled 1606, and the user who originally verified the email address associated with the university may be provided 1607 a push notification stating that the enablement was complete. He or she may then use the push notification to access a menu 1608 provided on his or her mobile device, and the process may then continue as previously described in the context of FIG. 15.

Other variations may also be possible. For example, in some embodiments, rather than, or in addition to, populating a profile for an institution once a user associated with that institution has tried to sign up, profile information for a university may be added preemptively so that when a user tries to sign up, information about that institution may already be available. Similarly, in some embodiments there may be functionality for allowing information for an institution to be automatically populated and/or propagated between profiles. For example, in some embodiments, information may be tagged with geography and/or geographic applicability. For instance, a national suicide prevention hotline could be tagged as nationally applicable, the presence of a fraternity or sorority could be tagged as applicable to a specific institution only, and particular laws or ordinances could be tagged as being local, state or national, depending on their reach. In such an embodiment, when a new institution was added, it could have a profile that was automatically populated with applicable state, local and national information depending on its location. Similarly, in some embodiments, when new information was added for a university, the information could be tagged as being applicable at the state, local, or national level, so that it could be automatically propagated to future universities as needed.

In some embodiments where it is present, informational location tagging may be used for more than (or for other purposes than) creating profiles for universities. For example, consider a case where a user attending one university (e.g., Michigan State University, located in East Lansing) goes to visit friends at a different university for the weekend (e.g., University of Michigan, located in Ann Arbor). In some embodiments, an application running on the user’s mobile device may detect that he or she has changed locations, and provide a prompt asking if the user wants to switch to information associated with the new location. Alternatively, in some embodiments, the location change may be detected, and the application may automatically switch to information for the new location (e.g., by caching information for confidential support, law enforcement, sexual assault reporting, etc. for the new location on the user’s mobile device; by, when a user requests information that varies from location to location, sending a tag to a database from which the information would be retrieved indicating the user’s current location rather than his or her default location; etc.). In this type of embodiment, the user may always be given location specific information that matches his or her current location even though the interface on his or her mobile device may be the same from location to location.

Location based information provision may also be used in some embodiments which may not associate individual users with institutions. For example, in some embodiments, rather than prompting for an institutional email, a system implemented based on this disclosure may collect an individual’s location (e.g., by prompting the user to provide his or her address, by detecting the user’s location using an IP address, GPS coordinates or other automatically collected information, etc.). A geographic area corresponding to the user’s location (e.g., a city, a county, a zip code, etc.) could then be determined, and could be used for purposes similar to a university in the example discussed in the context of FIG. 9. For instance, geographic entities could be associated with various civic organizations, and those civic organizations could be used to allow a user to populate his or her profile, in a manner similar to the use of fraternities or sororities in the university setting. Other variations may also be possible, and could be implemented based on this disclosure. Accordingly, the above description of university associated profiles should be understood as being illustrative only, and should not be treated as limiting.

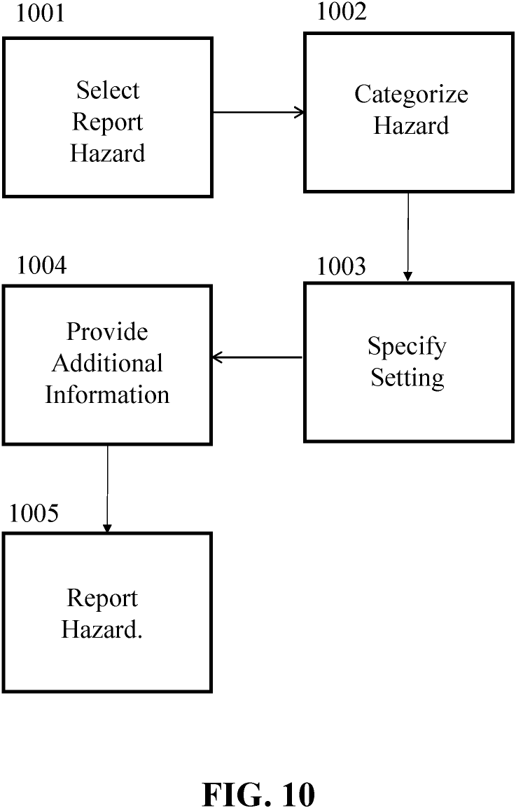

Other location based functionality may be provided in some embodiments, either in addition to, or instead of, one or more of the location based features described above. To illustrate, consider an embodiment in which a mobile application is implemented based on this disclosure to provide functionality for alerting students to hazards they may encounter in a university setting. In such an embodiment, a user may be provided with a tool allowing him or her to report hazards using a process such as shown in FIG. 10. Initially, in a process such as shown in FIG. 10, a user would provide an input to his or her mobile device indicating a desire to report a hazard 1001 (e.g., touching a report hazard icon presented by an application running on his or her mobile device). The user would then be allowed to specify the type of hazard being reported, preferably by identifying a category for the hazard 1002 (e.g., creeper, verbal harassment, danger, biohazard, caution or police), and potentially also specifying a subcategory for the hazard (e.g., a user reporting a creeper hazard may be presented with an interface where he or she could specify the hazard involved groping, being followed, someone taking photos, indecent exposure, or similar behavior). Preferably, each of the categories of hazards would have between 3-8 different types of subcategories associated with it, though it should be understood that this is not a requirement for all embodiments, and that some embodiments may have fewer (or more, or no) subcategories for one or more categories of hazard.

In an embodiment following a process such as shown in FIG. 10, after the user had categorized 1002 the hazard, he or she could be allowed to specify 1003 a setting for the hazard, such as that it occurred outdoors, on public transit or in a classroom. In embodiments where this type of specification 1003 is supported, it may provide a useful supplement to location information automatically determined through means such as a global positioning system installed in the user’s mobile device. The user may also be allowed to provide 1004 other information regarding the hazard, such as number and/or gender of people involved, and any comments that the user may want to associate with the hazard. Once the user has entered/selected the information for the hazard in his or her mobile application, the hazard could then be reported 1005. This could include, for example, storing the information regarding the hazard, potentially including both the information provided by the user as well as automatically collected information such as location and time, in a database in a system used in conjunction with the mobile application (e.g., the application database 203 from FIG. 2). Reporting 1005 may also include (e.g., by automatically triggering) push notifications to anyone else using the mobile application who may be impacted by the hazard (e.g., individuals within a set radius, such as one kilometer, of the hazard).

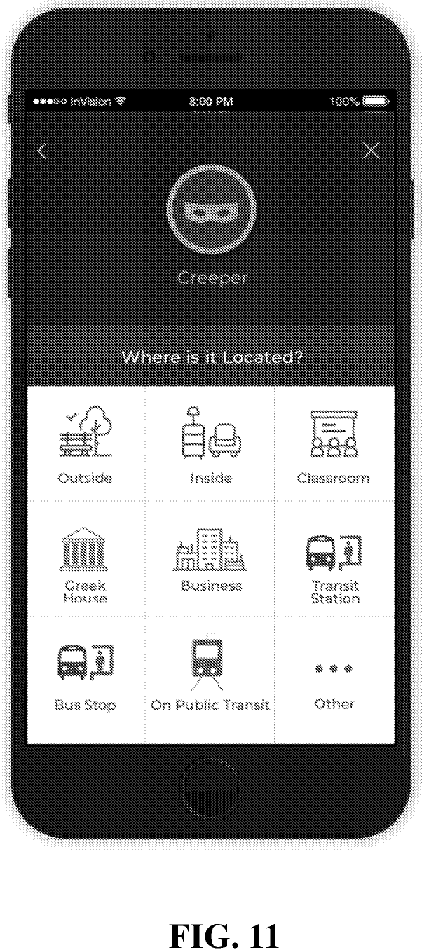

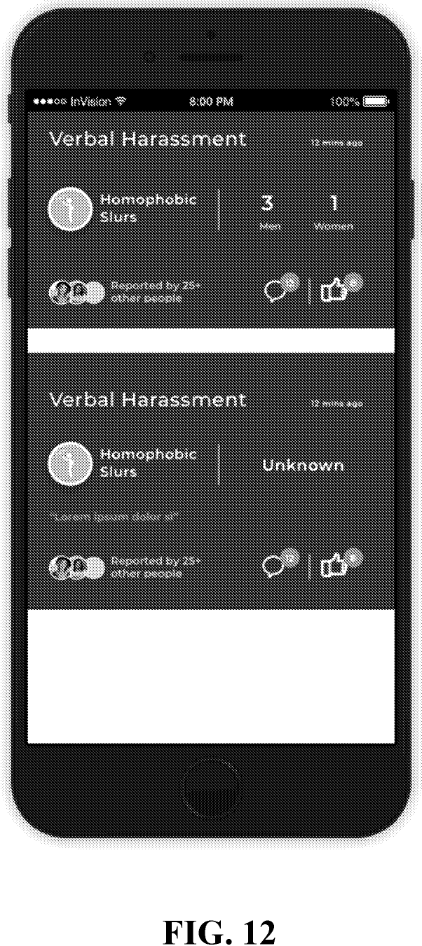

In an embodiment which permits reporting of hazards using a process such as shown in FIG. 10 (or another process, as may be more appropriate for a particular context), a mobile application may allow users to view previously reported hazards, such as in a list of nearby hazards or in a map view showing the location(s) of the hazard(s) relative to the user’s location. In some embodiments, these type of hazard notifications may allow a user to select a hazard to see more information (e.g., subcategory and other information provided by the user who originally reported the hazard), and potentially comment on (and/or see other people’s comments on) the hazard. Where users after the individual who initially reported the hazard are given the opportunity to provide subsequent information, there may also be a tool provided for such users to indicate if the hazard was (or was not) still active, or to see how many other users had provided information on the hazard (e.g., a number indicating how many comments had been left regarding a hazard could be displayed proximate the hazard in a map or list view). Examples of interfaces which could be used in reporting and providing subsequent information on hazards are provided in FIGS. 11 and 12, in which FIG. 11 illustrates an interface which could be used in specifying 1003 a setting for a creeper, and FIG. 12 illustrates an interface in which a user could provide additional information on a previously reported incident of verbal harassment.

Additionally, in some embodiments, either a subsequent user or a user who initially reports a hazard (or both) may be provided tools for providing targeted messages regarding the hazard. For example, in some embodiments, a mobile application may allow a user to initiate a (potentially anonymous) chat with campus security regarding a hazard, or to make an audio or video recording regarding the hazard, save it to a back end database, and then provide a link to the audio or video to campus security, such as for evidentiary or reporting purposes. As another example, in some embodiments, a user may be provided with a “distress signal” tool which, they activated it, would automatically send a push notification to one or more people or groups of people (e.g., the user’s active groups, such as discussed previously in the context of embodiments which provide user defined group functionality) and/or would cause an icon representing the user to appear on map interfaces presented on his or her friends’ mobile devices with some kind of distinguishing feature (e.g., growing larger and smaller, changing color, etc.) to show that the user was in distress. In embodiments providing this type of functionality, when one of the recipients of the “distress signal” had received it and was responding, he or she could be presented with a tool which would allow him or her to automatically notify the original signal’s recipients (which, in some cases, may include individuals who were not in groups with, or not even friends with, the person responding) that he or she was responding to the signal. Other variations on how information could be captured and distributed in the context of hazards (e.g., an algorithm which would track if a threshold number of high impact hazards were reported by people at a certain institution within a defined time period, and would send a push notification to all app users at the institution if the threshold was exceeded) are also possible, and could be implemented based on this disclosure by those of ordinary skill in the art. Accordingly, the preceding description of potential approaches that could be used for hazard reporting and notification should be understood as being illustrative only, and should not be treated as limiting.

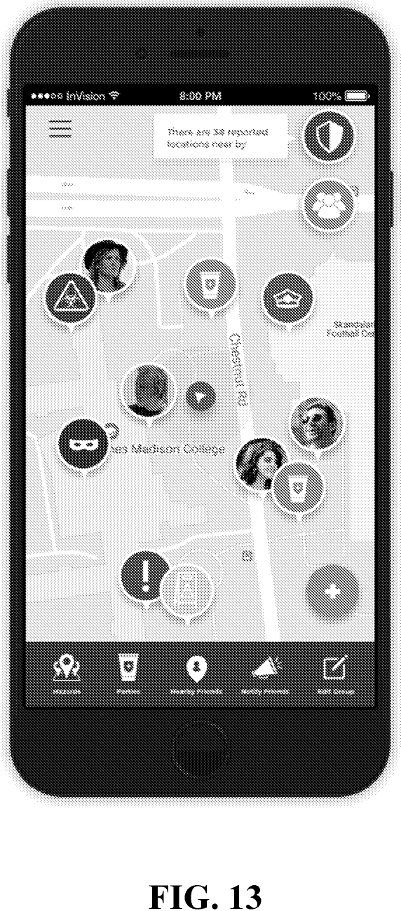

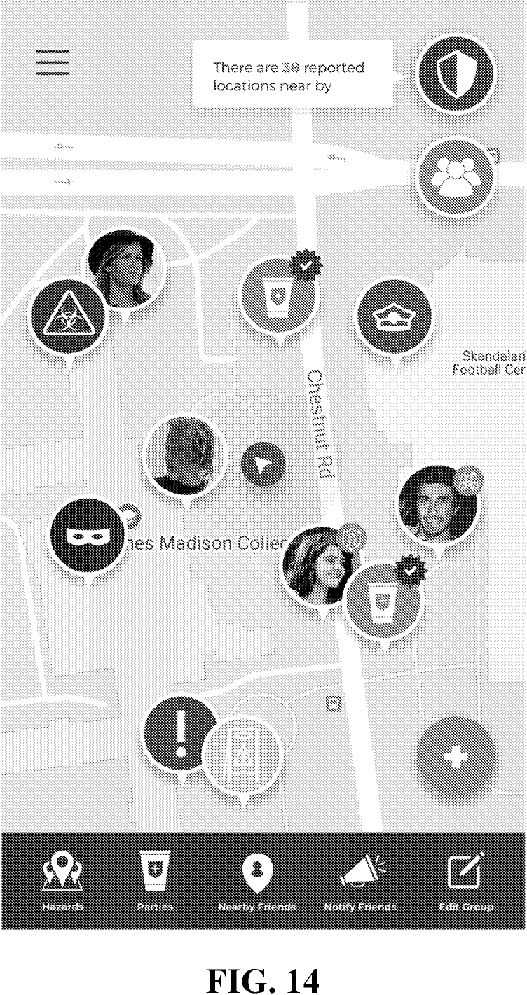

Just as there are variations on how hazard reporting and notification may be implemented in embodiments that support such functionality, there are also embodiments in which functionality described in the context of hazard notification and reporting could be used for other purposes. To illustrate, consider the example of map based information provision, described in the context of location based hazard reporting and notification. In some embodiments, a map based interface may be used to provide information other than the location of current hazards, such as locations of current parties or of the user’s nearby friends (or nearby members of the user’s active groups, in an embodiments which supported such relationships). An example of this type of interface is shown in FIG. 13, in which parties are displayed with cup icons, nearby friends are displayed with their pictures, and hazards are displayed with icons indicating the type of hazard identified at a particular location. In some embodiments which provide this type of interface, a user may be able to access and/or add additional information by selecting a particular item on the map interface. For example, by selecting a party icon, a user may be provided with additional information such as who the sober monitor(s) and/or risk manager(s) are (or whether they are present at all). Additionally, in some cases, the map interface itself may provide further information without a user having to select an icon or take similar action. For example, in some cases, when it is detected that an individual with the sober monitor or risk manager role is present at a party, then that party could be considered to be a monitored party, and a checkmark could be placed on its icon to indicate this status. An example of an interface with such a checkmark present is presented in FIG. 14. The user may also be provided with opportunities to rate or provide other feedback (e.g., comments) on a party, and/or to see ratings or other feedback that other people had already left.

Further variations on how systems implemented based on this disclosure control and/or provide access to information are also possible. For instance, in some embodiments, the same type of information and/or functionality described above as potentially being made available regarding parties from a map interface may be made available by selecting an invitation to the party instead. Similarly, some embodiments may be implemented to support a “Notify Friends” scenario, in which a user would open an interface displaying groups he or she is a part of (in some embodiments, this may be done from a main menu screen such as shown in FIG. 3, may be done from a map screen such as shown in FIG. 13, or both) and selects an active group. In this type of scenario, the user may then be presented with and select an option to notify friends. At this point, a group name may be displayed. This may include everyone in that group who will get the notification. The user may be allowed to delete individuals from the group and add whomever they choose or they can add people along with the group members. The user may also be allowed to select a notification option (e.g., notify when the user leaves or arrives at a location). The user may be allowed to select a search bar to change the location associated with the notification trigger, and the user may enter an address or specify a location by touching an icon on a map.

As another example of a scenario which may be supported in some implementations, consider the potential for some embodiments to utilize heart rate variability or other physiological information. For example, in some cases, a mobile application implemented based on this disclosure could be installed on a wearable device (e.g., an Apple Watch), or on a non-wearable mobile computing device which is connected with sensors capable of detecting physiological information (e.g., a Bluetooth enabled heart rate monitor). In such a case, the application may generally operate in a light mode, in which it performs background functions such as tracking location as described previously using GPS sensors, pings to WiFi networks or beacons, or other location tracking approaches. This information may be used for purposes such as supporting map functionality, as described infra, and may also be used to create a log of the user’s location, which log may be stored on the device itself and/or the cloud, and which may be deleted after a user specified time period for privacy reasons. Additionally, the application may continuously monitor the user’s physiological information to determine if it should switch out of the light mode into a more intensive processing mode. For example, if the application detected that the user’s heart rate variability indicates that the user is afraid, it may automatically switch to an intensive mode. In this intensive mode, the application may activate additional sensors (e.g., camera and microphone, to capture audio and video of the user’s surroundings), send information captured by those sensors to the cloud, and may also analyze the captured information to determine whether (and what) alerts to send to others.

In embodiments where an application may switch to an intensive made based on physiological information (e.g., heart rate variability), various approaches may be used to determine when this switch should be made. For example, in some cases, physiological data (e.g., heart rate variability) may be measured over an extended period to determine a baseline and normal variation for a user. Subsequently, when the user’s heart rate variability indicated he or she was in a highly fearful state relative to this baseline (e.g., heart rate variability significantly below baseline) this could be treated as a trigger to switch to the more intensive data collection mode. Other approaches, such as exposing a user to fear inducing stimuli (e.g., pre-selected audio-video stimuli) and physiological information collected during exposure to such stimuli to define a threshold for automatically switching to a more intensive data collection mode. Other types of changes to physiological information beyond those associated with fear responses may also be used to trigger a switch into an intensive data collection mode. For example, in some cases, if a user’s heart rate variability indicates that he or she has lost consciousness (e.g., by matching a pattern established previously when the user was asleep), this may automatically trigger transition into an intensive data collection mode (and/or triggering sending a distress signal to one or more of the user’s groups). Accordingly, the examples described above should be understood as being illustrative only, and should not be treated as implying limitations on how physiological information may be used in various embodiments.

To give a practical example of how the switch from a light mode to an intensive mode based on physiological information may work, consider a case where a user is walking in a park. Initially, the user may be using a wearable device running an application implemented based on this disclosure in light mode. In that mode, the application may record the user’s location and send it to a cloud server (e.g., an information server), and may also monitor the user’s physiological information (e.g., heart rate variability) to determine if the user had had an emotional change (e.g., become afraid) such that a switch to intensive mode would be appropriate. Such a switch to intensive mode may be triggered if, for example, the user sees two cars pull up and begin shooting at each other. This may cause the user to become afraid which, in turn, may cause the application to enter intensive mode. In this mode, it may automatically start recording audio and video, and may use the audio information to survey the user’s environment. Additionally, or alternatively, in some cases the application may automatically add a hazard notification to map interfaces (e.g., as illustrated in FIG. 13) displayed on devices within a predefined distance (e.g., 1 km) of the user’s location and/or may issue a distress signal to others in one or more of the user’s groups. In this way, the disclosed technology may protect its users in hazardous situations even when those users are not able to (or when they do not for some other reason, such as being distracted by circumstances) affirmatively request protection. It is also possible that, in some implementations, automatically protecting a user may be combined with manual protective actions as well. For example, in some cases, when a user’s physiological information indicated that he or she was becoming fearful, an application implemented based on this disclosure may automatically determine emergency services numbers for the user’s area (e.g., 911, police department, fire department, etc.) and present the user with a one touch interface to be automatically connected with those services. Accordingly, the illustrated automatic protective measures described above should be understood as being illustrative only, and should not be treated as limiting.

As yet another example of a potential application of aspects of the disclosed technology, consider the functionality of identifying the location of a monitor. For example, in some embodiments, a user may check into a party, and select a map pin icon in an interface such as shown in FIG. 6 next to a monitor. This may result in a map interface opening and showing the user the monitor’s location. The user may click on the party monitor’s pinned avatar and a slider may come up showing information about him or her. The user may then click on a messenger icon for his or more, and a screen such as shown in FIG. 7 may be presented asking if the user would like to speak with the monitor, including the buttons “anonymous” and “display name.” The user may then open the messenger to speak directly with the monitor, and may also be provided with tools such as back arrows and may see a list of previous messages and a list of monitors for the party (potentially in combination with an option to communicate with them), as well as whether they were active/inactive at that time.

As another example of a potential application, consider the incorporation of alerts into a system based on the disclosed technology. For example, in some cases, one or more users (e.g., a group of users, in embodiments which support that functionality) may be designated to keep each other safe at an event they will attend. Each of the users who is designated to keep each other safe may be provided an interface in which the profile pictures of the people he or she is to keep safe at the event are matched against images captured using the user’s front facing camera, so that the user would not inadvertently lose track of the relevant individuals . In such a case, if a user who is designated to keep another user safe loses track of the user he or she is to keep safe, that user may issue an alert similar to the “distress signal” described previously so that the other users in the relevant group at the event can know to look out for the missing user. In some embodiments, similar profile matching could also be applied to risk managers, sober monitors, and/or others with similar roles to help event attendees locate and communicate with them. In some embodiments, second party distress signal activation may be provided in contexts other than when someone has been lost track of at a party. For example, in some embodiments, if a user indicates that he or she is leaving a party and doesn’t arrive at his or her expected destination within a reasonable time thereafter, another user designated in a role such as party buddy or roommate may be able to trigger an alert that would notify the missing user’s active groups (or others, depending on the embodiment) that the missing user may be in trouble.

It should be understood that, while the above disclosure focused on embodiments which provided various types of information access and communication functionality in the context of a university setting, this is not a requirement for the disclosed technology. For example, while, as described above, user defined groups may be used for providing notifications among college students, groups defined as described herein may also be used for purposes such as defining individuals who would be provided access to resources (or authority to perform certain actions on database resources, such as editing them) in a non-collegiate setting, such as network database administration. Similarly, while certain examples may have described functionality as being performed by a server or an application, it should be understood that all such descriptions contemplate that such functionality could be provided by the execution of instructions on a mobile device, by the execution of instructions on a server, or by the combined actions of a mobile device and server. Accordingly, in light of the potential for variations on implementations, embodiments and applications of the disclosed technology, the examples, figures and other descriptive material provided herein should not be treated as implying limitations on the protection provided by this document or any related document. Instead, the protection provided by such document should be defined based on its claims when the terms in those claims are given their broadest reasonable interpretation as provided by a general purpose dictionary, supplemented by any definitions set forth under a heading where they are explicitly identified as “Explicit Definitions.”

### Explicit Definitions

When used in the claims, the phrase “based on” may be read as indicating that a thing is determined at least on part on what it is indicated as being “based on.” “Based EXCLUSIVELY on” may be read as indicating that a thing is required to be determined entirely by what it is indicated as being “based EXCLUSIVELY on.”

When used in the claims, the phrase “human intelligible identifier” should be understood to mean information, such as a first and last name, which a human being can reasonably be expected to associate with an identifiable natural person through the use of their unaided memory.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. A system comprising:
(a) a mobile device operable by a chat requestor to submit an anonymous chat request to an information server, wherein the anonymous chat request comprises a profile identifier for the chat requestor and a profile identifier for an intended chat recipient;
(b) the information server, wherein the information server is adapted to, in response to receiving the anonymous chat request, perform a set of steps comprising:
(i) retrieving an endpoint for the intended chat recipient from an application database;
(ii) creating a synthetic chat request, wherein the synthetic chat request comprises:
(A) an endpoint corresponding to the chat requestor; and
(B) the endpoint for the intended chat recipient;
(iii) sending the synthetic chat request to a chat server; and
(iv) storing a record identifying the synthetic chat request as corresponding to the anonymous chat request.

2. The system of claim 1, wherein the synthetic chat request does not comprise the profile identifier or any human intelligible identifier for the chat requestor.

3. The system of claim 1, wherein:
(a) the endpoint corresponding to the chat requestor is a first internet protocol address; and
(b) the endpoint for the intended chat recipient is a second internet protocol address.

4. The system of claim 1, wherein:
(a) the mobile device is operable to:
(i) present the chat requestor an interface listing individuals having one or more designated roles as potential chat recipients; and
(ii) allow the chat requestor to create the anonymous chat request by selecting an individual from the interface listing individuals having one or more designated roles; and
(b) the profile identifier for the intended chat recipient which is comprised by the anonymous chat request identifies the individual selected from the interface listing individuals having one or more designated roles.

5. The system of claim 4, wherein:
(a) the mobile device is operable to transmit geolocation for the chat requestor to the information server;
(b) the information server is configured to determine the context of the chat requestor by performing steps comprising:
(i) receiving location information from the mobile device;
(ii) comparing location information received from the mobile device with location information previously received for a plurality of predefined events; and
(iii) based identifying a predefined event from the plurality of predefined events having location information matching location information received from the mobile device, identify that predefined event as the context of the chat requestor.

6. The system of claim 4, wherein:
(a) the mobile device is operable by the chat requestor to specify that the chat requestor is present at an event; and
(b) the information server is configured to determine the context of the chat requestor based on receiving a signal from the mobile device indicating that the chat requestor is present at the event.

7-15. (canceled)

16. A system comprising:
(a) an information server;
(b) a physiological sensor adapted to collect physiological data from a user; and
(c) a mobile device associated with the user and configured with instructions operable to, when executed, to cause it to perform acts comprising:
(i) operating in a first mode, wherein, when operating in the first mode, the mobile device performs acts comprising analyzing physiological data from the user and determining, based on the analysis of the physiological data from the user, whether to operate in a second mode;
(ii) operating in the second mode, wherein, when operating in the second mode, the mobile device performs acts comprising:
(A) capturing location information through a location sensor of the mobile device;
(B) capturing audio information through a microphone of the mobile device; and
(C) transferring the audio information, the location information, and the physiological data to the information server.

17. The system of claim 16, wherein:
(a) the physiological sensor is a heart rate sensor;
(b) the mobile device is configured to establish a baseline heart rate variability for the user;
(c) analyzing the physiological data from the user comprises determining:
(i) the user’s heart rate variability; and
(ii) whether the user has had a decrease in heart rate variability relative to the baseline heart rate variability for the user.

18. The system of claim 16, wherein the information server is adapted to:
(a) store data identifying a plurality of other users as being comprised by an active group for the user; and
(b) based on the mobile device operating in the second mode, sending a notification to each of the other users identified as being comprised by the active group for the user.

19. The system of claim 16, wherein the information server is adapted to:
(a) identify an emergency services number based on the location information transferred from the mobile device; and
(b) based on the mobile device operating in the second mode, providing an interface operable by the user to access emergency services using the identified emergency services number.

20. The system of claim 16, wherein:
(a) the system comprises a plurality of additional mobile devices, each of which is adapted to display a map interface; and
(b) the information server is adapted to, based on the mobile device operating in the second mode, communicating information to each of the plurality of additional mobile devices causing that mobile device to display a hazard marker on the map interface at a location corresponding to the location information captured through the location sensor of the mobile device associated with the user.

21. A method performed by an information server, the method comprising:
(a) receiving an anonymous chat request from a mobile device, wherein the anonymous chat request comprises a profile identifier for a chat requestor and a profile identifier for an intended chat recipient;
(b) in response to receiving the anonymous chat request:
(i) retrieving an endpoint for the intended chat recipient from an application database;
(ii) creating a synthetic chat request, wherein the synthetic chat request comprises:
(A) an endpoint corresponding to the chat requestor; and
(B) the endpoint for the intended chat recipient;
(iii) sending the synthetic chat request to a chat server; and
(iv) storing a record identifying the synthetic chat request as corresponding to the anonymous chat request.

22. The method of claim 21, wherein the synthetic chat request does not comprise the profile identifier or any human intelligible identifier for the chat requestor.

23. The method of claim 21, wherein:
(a) the endpoint corresponding to the chat requestor is a first internet protocol address; and
(b) the endpoint for the intended chat recipient is a second internet protocol address.

24. The method of claim 21, wherein:
(a) the mobile device is operable to:
(i) present the chat requestor an interface listing individuals having one or more designated roles as potential chat recipients; and
(ii) allow the chat requestor to create the anonymous chat request by selecting an individual from the interface listing individuals having one or more designated roles; and
(b) the profile identifier for the intended chat recipient which is comprised by the anonymous chat request identifies the individual selected from the interface listing individuals having one or more designated roles.

25. The method of claim 24, wherein:
(a) the mobile device is operable to transmit geolocation for the chat requestor to the information server;
(b) the information server is configured to determine the context of the chat requestor by performing steps comprising:
(i) receiving location information from the mobile device;
(ii) comparing location information received from the mobile device with location information previously received for a plurality of predefined events; and
(iii) based identifying a predefined event from the plurality of predefined events having location information matching location information received from the mobile device, identify that predefined event as the context of the chat requestor.

26. The method of claim 24, wherein:
(a) the mobile device is operable by the chat requestor to specify that the chat requestor is present at an event; and
(b) the information server is configured to determine the context of the chat requestor based on receiving a signal from the mobile device indicating that the chat requestor is present at the event.

27-35. (canceled)

36. A method performed by a mobile device, the method comprising:
(a) operating in a first mode, wherein when operating in the first mode, the mobile device performs acts comprising:
(i) analyzing physiological data for a user; and
(ii) determining, based on the analysis of the physiological data from the user, whether to operate in a second mode;
(b) operating in a second mode, wherein when operating in the second mode, the mobile device performs acts comprising:
(i) capturing location information through a location sensor;
(ii) capturing audio information through a microphone; and
(iii) transferring the audio information, the location information, and the physiological data to an information server.

37. The method of claim 36, wherein:
(a) the mobile device is adapted to gather the physiological data using a heart rate sensor;
(b) the mobile device is configured to establish a baseline heart rate variability for the user;
(c) analyzing the physiological data from the user comprises determining:
(i) the user’s heart rate variability; and
(ii) whether the user has had a decrease in heart rate variability relative to the baseline heart rate variability for the user.

38. The method of claim 36, wherein the information server is adapted to:
(a) store data identifying a plurality of other users as being comprised by an active group for the user; and
(b) based on the mobile device operating in the second mode, sending a notification to each of the other users identified as being comprised by the active group for the user.

39. The method of claim 36, wherein the information server is adapted to:
(a) identify an emergency services number based on the location information transferred from the mobile device; and
(b) based on the mobile device operating in the second mode, providing an interface operable by the user to access emergency services using the identified emergency services number.

40. The method of claim 36, wherein the information server is adapted to, based on the mobile device operating in the second mode, communicating information to each of a plurality of additional mobile devices causing each of those mobile devices to display a hazard marker on a map interface at a location corresponding to the location information captured through a location sensor of the mobile device.

41. A system comprising:
(a) an information server, configured to maintain data for a plurality of events, wherein, for each event, the data for that event comprises:
(i) a location for that event;
(ii) a time period for that event;
(iii) for each of a plurality of predefined roles, one or more corresponding individuals; and
(iv) during the time period for that event, for each individual corresponding to a role from the plurality of predefined roles, whether that individual is present at that event;
(b) a plurality of mobile devices, wherein each of the plurality of mobile devices:
(i) is communicatively connected to the information server; and
(ii) is operable to display a map interface, the map interface corresponding to a geographic area and comprising icons representing one or more events having locations within the geographic area;
wherein for each icon comprised by the map interface which represents an event, the map interface provides a signal during the time period of that event based on the presence of one or more individuals corresponding to the one or more predefined roles.

42. The system of claim 41, wherein, for each icon comprised by the map interface for which the signal is provided, the signal is a marker displayed with that icon.

43. The system of claim 41, wherein, for each mobile device from the plurality of mobile devices, the one or more events having locations within the geographic area represented by icons on the map interface are determined based on the information server maintaining data indicating that those events are public events or are private events to which a user associated with that mobile device has been invited.

44. The system of claim 41, wherein:
(a) the one or more predefined roles comprises a plurality of predefined roles; and
(b) for each mobile device from the plurality of mobile devices, for each of the one or more events represented by icons on the map interface, that mobile device is operable to provide the signal during the time period of that event based on at least one individual corresponding to at least one of the predefined roles for that event being present at that event.

45. A method comprising:
(a) an information server maintaining data for a plurality of events, wherein, for each event, the data for that event comprises:
(i) a location for that event;
(ii) a time period for that event;
(iii) for each of a plurality of predefined roles, one or more corresponding individuals; and
(iv) during the time period for that event, for each individual corresponding to a role from the plurality of predefined roles, whether that individual is present at that event;
(b) the information server sending, to each mobile device of a plurality of mobile devices, data operable to configure that mobile device to display a map interface, the map interface corresponding to a geographic area and comprising icons representing one or more events having locations within the geographic area; wherein for each icon comprised by the map interface which represents an event, the map interface provides a signal during the time period of that event based on the presence of one or more individuals corresponding to the one or more predefined roles.

46. The method of claim 45, wherein, for each icon comprised by the map interface for which the signal is provided, the signal is a marker displayed with that icon.

47. The method of claim 45, wherein, for each mobile device from the plurality of mobile devices, the one or more events having locations within the geographic area represented by icons on the map interface are determined based on the information server maintaining data indicating that those events are public events or are private events to which a user associated with that mobile device has been invited.

48. The method of claim 45, wherein:
(a) the one or more predefined roles comprises a plurality of predefined roles; and
(b) for each mobile device from the plurality of mobile devices, for each of the one or more events represented by icons on the map interface, that mobile device is operable to provide the signal during the time period of that event based on at least one individual corresponding to at least one of the predefined roles for that event being present at that event.
